(19) United States
(12) Patent Application Publication
(10) Pub. No.: US 2025/0245672 A1
(43) Pub. Date: Jul. 31, 2025

(54) ADJUSTING INCIDENT PRIORITY

(71) Applicant: PagerDuty, Inc., San Francisco, CA (US)

(72) Inventors: Gordon R. Towne, San Francisco, CA (US); Weiyu Max Li, San Francisco, CA (US); Irena Grabovitch-Zuyev, San Francisco, CA (US); Everaldo Aguiar, San Francisco, CA (US); Dylan Lingelbach, San Francisco, CA (US)

(21) Appl. No.: 18/428,323

(22) Filed: Jan. 31, 2024

(51) Int. Cl. G06Q 30/015

(52) U.S. Cl. CPC G06Q 30/015

(57) ABSTRACT

An operations computing system receives event data for one or more events and generates, based on the event data, an incident object for an incident. The incident object includes incident data including a priority level. The operations computing system generates an incident workflow for the incident object. The operations computing system applies, using an application programming interface, a machine learning model to determine an adjusted priority level for the incident object, in which the machine learning model is configured to receive one or more valid natural language prompts related to incident priority level. The operations computing system receives the adjusted priority level for the incident object, and updates the incident object associated with the incident workflow with the adjusted priority level. The operations computing system performs one or more actions included in the incident workflow for the incident object based on the adjusted priority level for the incident workflow.

### TECHNICAL FIELD

This disclosure relates generally to adjusting priority levels of incidents using artificial intelligence.

### BACKGROUND

Operations computing systems may manage incidents triggered by events in computing systems that are registered to customer sites. However, these incidents may have different levels of severity or urgency. As such, there is a need to triage incident data such that operations computing systems may address incidents in order of priority.

### SUMMARY

Aspects of the present disclosure describe techniques for adjusting priority levels of incidents by applying a machine learning model configured to receive natural language prompts. In general, an operations computing system may generate, based on event data received from one or more customer computing systems, one or more incident objects for one or more incidents, in which the one or more incident objects include incident data, such as a priority level. The operations computing system may also implement one or more services to generate an incident workflow for each incident object that includes one or more actions for addressing the incident. The operations computing system may determine the priority level for the incident object based on, for example, one or more rules defined by a user for a specific incident. The operations computing system may be configured to apply, using an application programming interface, a machine learning model to determine an adjusted priority level for the incident object. The user may provide one or more natural language prompts indicative of incident data and/or additional instructions for determining the adjusted priority level for the incident object. The operations computing system may receive, from the machine learning model, the adjusted priority level for the incident object and a description indicative of how the adjusted priority level for the incident object was determined. The operations computing system may then update the incident object associated with the incident workflow with the adjusted priority level.

The techniques described herein may provide one or more technical advantages that realize one or more practical applications. For example, the operations computing system may more effectively triage event data from customer computing systems, such that incidents created with higher urgency levels or higher severity levels are addressed through workflows assigned with higher priority levels. In this way, high priority incidents may be escalated to a human user for mitigation more quickly. Furthermore, the operations computing system may allow users to easily fine-tune machine learning models used to determine priority levels, as the operations computing system may implement machine learning models that can receive natural language prompts as input. Additionally, by employing a system that determines incident priority levels based on a request (i.e., a natural language request) including natural language prompts may be desirable for reducing user interaction and increasing overall system performance. Furthermore, priority levels of incident objects may be determined more accurately, and thus incidents may be responded to in a more efficient and appropriate manner.

In one example, the disclosure is directed to a method that includes receiving, by a computing system, event data for one or more events, generating, by the computing system, and based on the event data, one or more incident objects for one or more incidents, wherein the one or more incident objects include incident data including a priority level, and generating, by the computing system, an incident workflow for each of the one or more incident objects. The method may further include applying, by the computing system, and using an application programming interface, a machine learning model to determine an adjusted priority level for each of the one or more incident objects, wherein the machine learning model is configured to receive a first natural language prompt indicative of incident data included in the one or more incident objects, receiving, by the computing system, the adjusted priority level for each of the one or more incident objects, and updating, by the computing system, the incident workflow for each of the one or more incident objects with the adjusted priority level for each of the one or more incident objects.

In another example, the disclosure is directed to a system that includes a memory and one or more processors having access to the memory. The one or more processors may be configured to receive event data for one or more events, generate, based on the event data, one or more incident objects for one or more incidents, wherein the one or more incident objects include incident data including a priority level, and generate an incident workflow for each of the one or more incident objects. The one or more processors may be further configured to apply, using an application programming interface, a machine learning model to determine an adjusted priority level for each of the one or more incident objects, wherein the machine learning model is configured to receive a first natural language prompt indicative of incident data included in the one or more incident objects, and wherein the adjusted priority level is determined based on a severity level and an urgency level. The one or more processors may be further configured to receive the adjusted priority level for each of the one or more incident objects, and update the incident workflow for each of the one or more incident objects with the adjusted priority level for each of the one or more incident objects, wherein the incident workflow includes one or more actions for addressing an incident from the one or more incidents, and wherein the system is configured to perform the one or more actions based on the adjusted priority level for the incident workflow.

In another example, the disclosure is directed to a computer-readable storage medium encoded with instructions that, when executed, cause at least one processor of a computing system to receive event data for one or more events, generate, based on the event data, one or more incident objects for one or more incidents, wherein the one or more incident objects include incident data including a priority level, and generate an incident workflow for each of the one or more incident objects. The at least one processor may be further configured to apply, using an application programming interface, a machine learning model to determine an adjusted priority level for each of the one or more incident objects, wherein the machine learning model is configured to receive a first natural language prompt indicative of incident data included in the one or more incident objects, and wherein the adjusted priority level is determined based on a severity level and an urgency level. The at least one processor may be further configured to receive the adjusted priority level for each of the one or more incident objects, and update the incident workflow for each of the one or more incident objects with the adjusted priority level for each of the one or more incident objects, wherein the computing system is further configured to receive user input to further adjust the adjusted priority level for each of the one or more incident objects, wherein the incident workflow includes one or more actions for addressing an incident from the one or more incidents, and wherein the computing system is configured to perform the one or more actions based on the adjusted priority level for the incident workflow.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF THE DRAWINGS

FIG. 1 is a block diagram illustrating an example system for generating incident workflows for addressing incidents triggered by events in one or more customer computing systems, in accordance with the techniques of this disclosure.

FIG. 2 is a block diagram illustrating an example computing system for adjusting priority levels of incident objects, in accordance with one or more techniques of this disclosure.

FIG. 3 is a conceptual diagram illustrating an example machine learning module for determining priority levels for incident objects, in accordance with techniques of this disclosure.

FIG. 4 is a conceptual diagram illustrating an example natural language prompt for adjusting priority levels of incident objects, in accordance with one or more aspects of the present disclosure.

FIG. 5 is a flow chart illustrating an example process of adjusting priority levels of incident objects, in accordance with one or more aspects of the present disclosure.

Like reference characters denote like elements throughout the text and figures.

### DETAILED DESCRIPTION

An example operations computing system may monitor, manage, or compare the operations of one or more organizations, such as a business, a company, an association, an enterprise, a confederation, or the like. The operations computing system may accept various events that indicate conditions occurring in the one or more organizations. The operations computing system may manage several separate organizations at the same time. For example, an event may be an indication of a state of change to an information technology service of an organization. An event can be or describe a fact at a moment in time that may consist of a single or a group of correlated conditions that have been monitored and classified into an actionable state. As such, a monitoring tool of an organization may detect a condition in the IT environment (e.g., such as the computing devices, network devices, software applications, etc.) of the organization and transmit a corresponding event to the operations computing system. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

The operations computing system described herein may determine how events should be resolved. Accordingly, the operations computing system may generate one or more incident objects for one or more incidents that are based on event data.

The operations computing system may generate an incident workflow for each of the one or more incident objects, in which a priority level may be assigned to the incident object and/or incident workflow. The operations computing system may determine the priority level based on rules, conditions, notification rules, escalation rules, routing keys, or the like, or combination thereof, that may be associated with different types of events. For example, the operations computing system may determine that some events (e.g., of the frequent type) may be informational rather than associated with a critical failure. However, other event data (or incident data) may indicate that a different priority level is needed for a particular incident. As such, the operations computing system may apply, using an application programming interface (API), a machine learning model to determine an adjusted priority level for the incident object and/or incident workflow. In this way, the computing system described herein may help to improve the triaging of event data, such that more urgent or more important incidents are assigned higher levels of priority and handled in a more appropriate and timely manner.

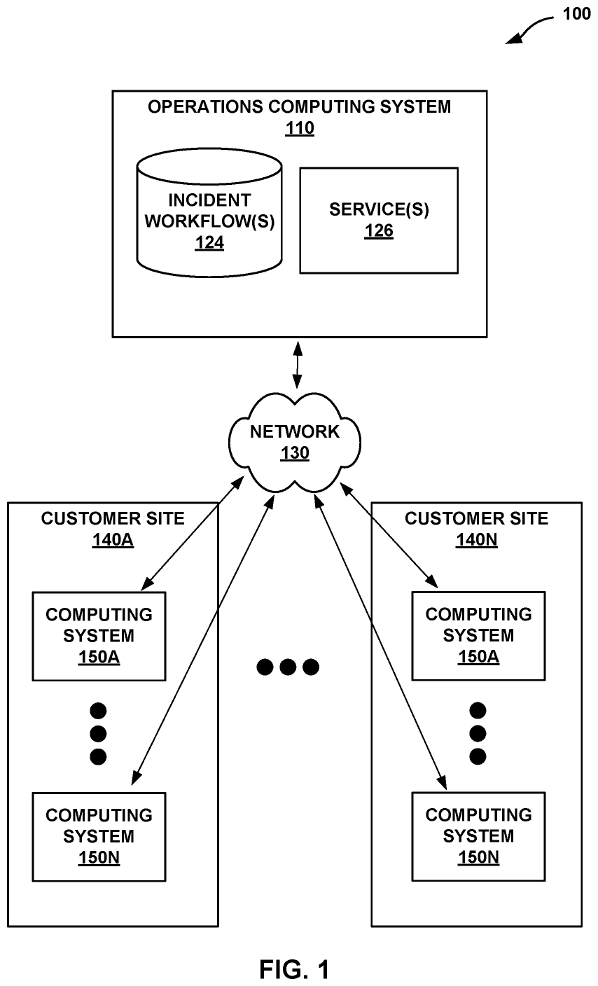

FIG. 1 is a block diagram illustrating an example system 100 configured to generate incident objects for addressing incidents triggered by events in one or more customer computing systems, in accordance with the techniques of this disclosure. In the example of FIG. 1, system 100 may include operations computing system 110, customer sites 140A-140N (collectively referred to herein as “customer sites 140”), and network 130.

Network 130 may include any public or private communication network, such as a cellular network, Wi-Fi network, or other type of network for transmitting data between computing devices. In some examples, network 130 may represent one or more packet switched networks, such as the Internet. Operations computing system 110 and computing systems 150 of customer sites 140, for example, may send and receive data across network 130 using any suitable communication techniques. For example, operations computing system 110 and computing systems 150 may be operatively coupled to network 130 using respective network links. Network 130 may include network hubs, network switches, network routers, terrestrial and/or satellite cellular networks, etc., that are operatively inter-coupled thereby providing for the exchange of information between operations computing system 110, computing systems 150, and/or another computing device or computing system. In some examples, network links of network 130 may include Ethernet, ATM or other network connections. Such connections may include wireless and/or wired connections.

Customer sites 140 may be managed by an administrator of system 100. In some instances, customer sites 140 may include a cloud computing service, corporations, banks, retailers, non-profit organizations, or the like. Each customer site of customer sites 140 (e.g., customer site 140A and customer site 140N) may correspond to different customers, such as cloud computing services, corporations, etc.

Each of customer sites 140 may include computing systems 150A-150N (collectively referred to herein as “computing systems 150”). In some examples, one or more of computing systems 150 may operate within a business or other entity corresponding to one or more of customer sites 140 to perform a variety of services for the business or other entity. For example, a computing system of computing systems 150 may operate as a cloud computing system that provides one or more services via network 130, a web server, an accounting server, a production server, an inventory server, or the like. However, computing systems 150 are not constrained to these services and may also be employed, for example, as an end-user computing node, in other embodiments. Further, it should be recognized that more or less computing systems may be included within a system such as described herein, and embodiments are therefore not constrained by the number or type of computing systems employed.

Computing systems 150 may include a collection of hardware devices, software components, and/or data stores that can be used to implement one or more applications or services related to business operations of respective customer sites 140. Computing systems 150 may represent a cloud-based implementation. In some examples, computing systems 150 may include, but are not limited to, portable, mobile, or other devices, such as mobile phones (including smartphones), wearable computing devices (e.g., smart watches, smart glasses, etc.) laptop computers, desktop computers, tablet computers, smart television platforms, server computers, mainframes, infotainment systems (e.g., vehicle head units), or the like.

Operations computing system 110 may include virtually any network computer configured to provide computer operations management services. Operations computing system 110 may implement various techniques for managing data operations, networking performance, customer service, customer support, resource schedules and notification policies, event management, or the like for computing systems 150. Operations computing system 110 may interface or integrate with one or more external systems such as telephony carriers, email systems, web services, or the like, to perform computer operations management.

Operations computing system 110 may monitor the performance of computer operations of customer sites 140. For example, operations computing system 110 may monitor whether applications or systems of customer sites 140 are operational, network performance associated with customer sites 140, trouble tickets and/or resolutions associated with customer sites 140, or the like. Operations computing system 110 may include applications with computer executable instructions that transmit, receive, or otherwise process instructions and data when executed.

As described herein, operations computing system 110 may receive event data corresponding to various events and/or performance metrics from computing systems 150 of customer sites 140. The term “event,” as used herein, can refer to one or more outcomes, conditions, or occurrences that may be detected (e.g., observed, identified, noticed, monitored, received, etc.) by operations computing system 110, which may perform functions similar to an event management bus. Operations computing system 110, as an event management bus (which can also be referred to as an event ingestion and processing system), may handle various types of events depending on the needs of an industry and/or technology area. For example, information technology services may generate events in response to one or more conditions, such as computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or a combination thereof. Other non-limiting examples of events may include a monitored operating system process not running, a virtual machine restarting, a disk space on a device is low, processor utilization on a device is higher than a threshold, a shopping cart service of an e-commerce site is unavailable, a digital certificate has expired or is expiring, a certain web server returning a 503 error code (indicating that web server is not ready to handle requests), a customer relationship management (CRM) system is down (e.g., unavailable) such as because it is not responding to ping requests, etc. In some examples, an event (e.g., an event object) may be directly created (such as by a human) in operations computing system 110 via user interfaces of operations computing system 110.

Event data may be provided to operations computing system 110 using one or more messages, emails, telephone calls, library function calls, application programming interface (API) calls, including, any signals provided to operations computing system 110 indicating that an event has occurred. One or more third party and/or external systems may generate event messages that are provided to operations computing system 110.

As described herein, event data corresponding to one or more events may be received by operations computing system 110, in which operations computing system 110 may generate, based on the event data, an incident object for an incident, in which operations computing system 110 may assign a priority level to the incident object. Operations computing system 110 may also generate an incident workflow for the incident object. In some examples, operations computing system 110 may additionally or alternatively assign a priority level to the incident workflow. Operations computing system 110 may then apply a machine learning model (e.g., a machine learning model stored in operations computing system 110 or a machine learning model externally hosted on a platform that a user can initiate an API call to) to determine an adjusted priority level for the incident object and/or incident workflow, and accordingly queue the incident workflow for processing. Processing an incident workflow can include triggering (e.g., creating, generating, instantiating, etc.) a corresponding alert in operations computing system 110, sending a notification of the incident to a responder (i.e., a person, a group of persons, etc.), and/or triggering a response (e.g., a resolution or set of actions) to the incident. An alert (an alert object) may be created (instantiated) for anything that requires the performance (by a human or an automated task) of an action. Thus, the alert may embody or include the action to be performed.

The term “incident” as used herein can refer to a condition or state in the managed networking environments that requires some form of resolution by a person or an automated service. Typically, incidents may be a failure or error that occurs in the operation of a managed network and/or computing environment. One or more events may be associated with one or more incidents. However, not all events may be associated with incidents.

The term “incident workflow” as used herein may refer to a set of configurable actions that will be automatically performed when an incident is created or updated. In some other examples, an incident workflow may refer to the actions, resources, services, messages, notifications, alerts, events, or the like, related to resolving one or more incidents. Accordingly, services that may be impacted by a pending incident, may be added to the incident workflow associated with the incident. Likewise, resources responsible for supporting or maintaining the services may also be added to the incident workflow. Further, log entries, journal entries, notes, timelines, task lists, status information, or the like, may be created or manipulated as part of an incident workflow.

In the example of FIG. 1, operations computing system 110 may include, but is not limited to, remote computing systems, such as one or more desktop computers, laptop computers, mainframes, servers, cloud computing systems, etc. capable of sending information to and receiving information from computing systems 150 via a network, such as network 130. Operations computing system 110 may host (or at least provides access to) information associated with one or more applications or application services executable by computing systems 150, such as operation management client application data. In some examples, operations computing system 110 represents a cloud computing system that provides the application services via the cloud. Moreover, operations computing system 110 may not be limited to a particular configuration. Operations computing system 110 may operate using a master/slave approach over a plurality of network computers, within a cluster, a peer-to-peer architecture, and/or any of a variety of other architectures. As such, operations computing system 110 is not to be construed as being limited to a single environment, and other configurations, and architectures are also contemplated. Operations computing system 110 may employ processes such as described below in conjunction with at least some of the figures discussed below to perform at least some of its actions.

Operations computing system 110 may generate one or more incident workflows for one or more incidents and store the incident workflows in incident workflows 124 (referred to herein as “incident workflows 124”). Operations computing system 110 may also include one or more services 126 (referred to herein as “services 126”). Services 126 may include software tools, such as software automation tools, software modules, software engines, application programming interfaces (APIs), etc. Services 126 (e.g., incident management applications) may orchestrate and process (e.g., perform actions of) incident workflows related to managing operations of customer computing systems (e.g., computing systems 150). Services 126 may include computer readable instructions that, when executed by operations computing system 110, fetch and/or process other tasks associated with computing systems 150. For example, services 126 may fetch and process tasks, such as generating alerts. Operations computing system 110 may enqueue incident workflows associated with managing customer computing systems in a database (e.g., incident workflows 124). As described herein, operations computing system 110 may implement a priority queuing technique to fetch and process incident workflows from the database, in which the incident workflows may be processed based on their assigned priority level (e.g., higher priority tasks are processed first, regardless of their position in the queue). As such, more critical or time-sensitive incidents may be resolved first. In some examples, operations computing system 110 may additionally implement other conventional techniques (e.g., weighted round-robin, Earliest Deadline First (EDF), multilevel queue, etc.) to fetch and process incident workflows from the database. Incident workflows 124 may include a data center, server room, computing devices, network devices, or the like for storing and/or organizing incident workflows associated with computing systems 150. Incident workflows 124 may be organized according to a database schema established by an administrator of operations computing system 110.

As described herein, incident workflows 124 may be associated with incident objects (e.g., a structured representation of an incident). An incident object may be a record that includes incident data, in which the incident data may further include one or more of the event data, an identifier, timestamps, incident type, incident source, severity level, urgency level, current incident status, one or more response actions, incident resolution, associated support tickets, and an action log.

The incident object may serve as the central piece of information that is processed and updated throughout the incident workflow. Incident workflows 124 may include incident objects with one or more identifier values (e.g., information associated with each incident), such as customer site identifiers, event identifiers, etc. For example, operations computing system 110 may assign each of customer sites 140 one or more identifier values to manage or group tasks associated with customer sites 140. In the example of FIG. 1, operations computing system 110 may assign an identifier value (e.g., a number, a hash value, a unique name, etc.) to each customer site of customer sites 140. For example, operations computing system 110 may assign customer site 140A an identifier value of “1401” and may assign customer site 140B an identifier value of “1454.” Operations computing system 110 may generate an incident object for a customer site to include an identifier value corresponding to the customer site of customer sites 140 associated with the incident object. In some examples, operations computing system 110 may include multiple identifier values and/or multiple index data structures in an incident object for a customer site based on tiers that are assigned individual identifier values.

Incident workflows 124 may include an incident object that points to a block of the database comprising computer readable instructions for processing the incident workflow. Although illustrated as being included in operations computing system 110, services 126 and/or incident workflows 124 may be included on one or more computing systems 150 of customer sites 140 or on any other computing device or computing system not shown. For example, services 126 and incident workflows 124 may be included in computing system 150A-1 to manage processing of incident workflows associated with customer site 140A.

In some examples, each workflow of workflows 124 may include multiple “jobs,” or multiple tasks executed by operations computing system 110. When responding to an incident, a user (i.e., a responder) may document the steps taken during the response that led to a resolution. Additionally, the user may want to automate those steps so that future responses to the same or similar incident types can be handled via automation (i.e., a job). As such, workflows 124 may include steps that may be grouped together and executed in a predefined order as a job, and workflows 124 may include multiple jobs. A job may be defined by a job definition. A job definition may detail each command to be executed and the order in which to execute the commands. As such, a job definition may include an ordered set of steps.

Incident workflows 124 may store incident workflows comprising tasks including, but not limited to, incident response diagnostic tasks, data distribution tasks, and/or service request automation tasks. Incident workflows 124 may store incident workflows that include a set of incident response diagnostic tasks such as enriching existing events with relevant data, logging incidents (e.g., time, date, and/or status of incidents), updating the status of a platform, updating the status of a service, updating the status of third party services, restarting services, restarting servers, unlocking databases, flushing storages, clearing files from memory, adding more disk or memory space, managing tickets (e.g., opening tickets, updating tickets, closing tickets), healing, incident escalation, etc. Incident workflows 124 may store incident workflows comprising a set of data distribution tasks such as job scheduling, extract-transform-load (ETL), file transfers, data removal, complex workflows or rules, data replication, data remodeling, database creation, etc. Incident workflows 124 may store incident workflows comprising a set of service request automation tasks such as infrastructure provisioning, automatically shutting down of unused cloud resources, managing users (e.g., onboarding users, deleting users, etc.), decommissioning hardware, adding servers, adding storage, software management (e.g., updating software, deploying software, etc.), managing cloud services (e.g., provisioning cloud services), opening ports, production patching, vulnerability patching, increasing capacity, establishing security procedures, validating security, changing configurations, adding Virtual Local Area Networks (VLANs), creating communication channels, adding server hosts, establishing firewall ports, validating Secure Sockets Layer (SSL) Certificates, getting Internet Protocol (IP) addresses, regulating IP addresses, benchmark testing, etc. In some instances, incident workflows 124 may store incident workflows comprising sets of tasks associated with customer sites 140 using software application tools, modules, engines, components, etc. that may identify tasks based on actions required for management of customer sites 140. Services 126 may obtain instructions to execute an incident workflow based on the incident object associated with the incident workflow.

In some examples, services 126 may obtain instructions to perform one or more actions included in the incident workflow from one or more engines or applications managed by operations computing system 110. Services 126 may include services that are designed to handle workflows for similar tasks. Services 126 may include specialized services that are managed and receive instructions from one or more applications implemented by operations computing system 110.

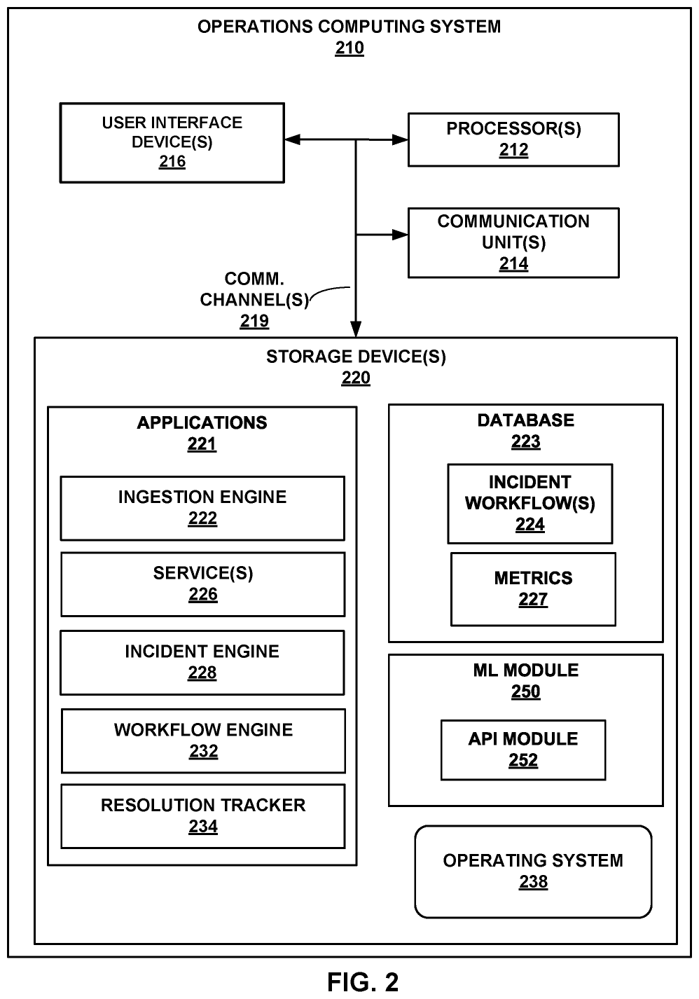

As described herein, operations computing system 110 may receive, from computing systems 150 and via network 130, event data for one or more events that occur at customer sites 140. Operations computing system 110 may generate, based on the event data, one or more incident objects for one or more incidents. Operations computing system 110 may generate an incident workflow for each incident object and store each incident workflow in incident workflows 124. Operations computing system 110 may also assign a priority level to each incident object and/or each incident workflow, such that services 126 fetch and process each incident workflow using a method of priority queuing. As described in more detail with respect to FIG. 2, however, to improve the triaging of event data and the queueing of incident workflows, operations computing system 110 may apply, using an application programming interface (API), a machine learning model to determine an adjusted priority level for each incident object and/or incident workflow. As described below, the machine learning model may receive a first natural language prompt indicative of incident data included in the one or more incident objects and output, to operations computing system 110, the adjusted priority level for each incident object and/or incident workflow. Operations computing system 110 may then update each of the one or more incident objects associated with a respective workflow with the adjusted priority level, such that that services 126 may fetch and process each incident workflow based on the adjusted priority levels. In this way, events that occur at customer sites 140 may be managed by operations computing system 110 in a more efficient and effective manner, in that more critical or time-sensitive incidents may be resolved first.

FIG. 2 is a block diagram illustrating an example computing system 210 for adjusting priority levels of incident objects, in accordance with one or more techniques of this disclosure. Operations computing system 210 may be an example implementation of operations computing system 110 of FIG. 1. In the example of FIG. 2, incident workflows 224 and services 226 may correspond to incident workflows 124 and services 126 of FIG. 1, respectively.

Computing system 210, in the example of FIG. 2, may include user interface (UI) devices 216, processors 212, communication units 214, and storage devices 220. Communication channels 219 (“COMM channel(s) 219”) may interconnect each of components 212, 214, 216, and 220 for inter-component communications (physically, communicatively, and/or operatively). In some examples, communication channel 219 may include a system bus, a network connection, an inter-process communication data structure, or any other method for communicating data.

UI devices 216 may function as an input device and/or an output device for operations computing system 210. UI device 216 may be implemented using various technologies. For instance, UI device 216 may receive input from a user through tactile, audio, and/or video feedback. Examples of input devices include a presence-sensitive display, a presence-sensitive or touch-sensitive input device, a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touch screen, or another presence-sensitive technology. That is, UI device 216 may include a presence-sensitive device that may receive tactile input from a user of operations computing system 210.

UI device 216 may additionally or alternatively function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, miniLED, microLED, organic light-emitting diode (OLED) display, e-ink, or similar monochrome or color display capable of outputting visible information to a user of operations computing system 210. Additional examples of an output device include a speaker, a haptic device, or other device that can generate intelligible output to a user. For instance, UI device 216 may present output as a graphical user interface that may be associated with functionality provided by operations computing system 210.

Processors 212 may implement functionality and/or execute instructions within operations computing system 210. For example, processors 212 may receive and execute instructions that provide the functionality of applications 221 and OS 238. These instructions executed by processors 212 may cause operations computing system 210 to store and/or modify information within storage devices 220 or processors 212 during program execution. Processors 212 may execute instructions of applications 221 and OS 238 to perform one or more operations. That is applications 221 and OS 238 may be operable by processors 212 to perform various functions described herein.

Storage devices 220 may store information for processing during operation of operations computing system 210 (e.g., operations computing system 210 may store data accessed by applications 221 and OS 238 during execution). In some examples, storage devices 220 may be a temporary memory, meaning that a primary purpose of storage devices 220 is not long-term storage. Storage devices 220 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 220 may include one or more computer-readable storage media. Storage devices 220 may store larger amounts of information than volatile memory. Storage devices 220 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage devices 220 may store program instructions and/or information (e.g., within database 223) associated with applications 221 and OS 238.

Communication units 214 may communicate with one or more external devices via one or more wired and/or wireless networks by transmitting and/or receiving network signals on the one or more networks. Examples of communication units 214 include a network interface card (e.g., such as an Ethernet card), an optical transceiver, a radio frequency transceiver, a GNSS receiver, or any other type of device that can send and/or receive information. Other examples of communication unit 214 may include short wave radios, cellular data radios (for terrestrial and/or satellite cellular networks), wireless network radios, as well as universal serial bus (USB) controllers.

OS 238 may control the operation of components of operations computing system 210. For example, OS 238 may facilitate the communication of applications 221 with processors 212, storage devices 220, and communication units 214. OS 238 may have a kernel that facilitates interactions with underlying hardware of operations computing system 210 and provides a fully formed application space capable of executing a wide variety of software applications having secure partitions in which each of the software applications executes to perform various operations.

Applications 221 may include ingestion engine 222, services 226, incident engine 228, workflow engine 232, and resolution tracker 234. Ingestion engine 222 may receive and/or obtain one or more different types of operations events provided by various sources. Ingestion engine 222 may obtain operations event data pertaining to one or more events, such as alerts regarding system errors, warnings, failure reports, customer service requests, status messages, or the like. Ingestion engine 222 may obtain event data that may be variously formatted messages that reflect the occurrence of events and/or incidents that have occurred in an organization's computing system (e.g., computing systems 150 of FIG. 1). Ingestion engine 222 may obtain event data that may include SMS messages, HTTP requests or posts, API calls, log file entries, trouble tickets, emails, or the like. Ingestion engine 222 may obtain event data that may be associated with one or more service teams that may be responsible for resolving issues related to the events. In some examples, ingestion engine 222 may obtain event data from one or more external services that are configured to collect event data.

Ingestion engine 222 may orchestrate various actions related to the obtained event data. Ingestion engine 222 may employ (e.g., generate computer-readable instructions, configure, etc.) one or more services of services 226 to perform the actions related to event data. For example, ingestion engine 222 may employ services 226 to filter event data, reformat event data, extract information from event data, or normalize event data. In some examples, ingestion engine 222 may determine whether the event data constitutes one or more incidents, and may generate one or more incident objects for each incident based on the event data. In other examples, services 226 may generate one or more incident objects for each incident based on operations performed by ingestion engine 222. For example, ingestion engine 222 or services 226 may determine incident data, such as a priority level, based on rules, conditions, notification rules, escalation rules, routing keys, or the like, or combination thereof, that may be associated with different types of events. For example, ingestion engine 222 or services 226 may determine that some events (e.g., of the frequent type) may be informational rather than associated with a critical failure. In some examples, data (e.g., unstructured data such as emails) may be associated with incidents that do not have a priority, in which ingestion engine 222 or services 226 may assign a default priority level to the incident object for the incident. In some examples, some or all of the incidents determined by operations computing system 210 may be assigned a default priority level. In some examples, an incident may not initially have an assigned priority level. As such, in some examples, workflows 224 may include an “incident workflow action” or “adjust incident priority” action that allows a user to assign the priority of an incident once the action is run. In some examples, as described herein, the “adjust incident priority” action may further adjust the default or initially assigned incident priority, e.g., some or all of the techniques described herein may be implemented responsive to the “adjust incident priority” action being executed.

Ingestion engine 222 may employ services 226 to perform various actions, such as storing incident data (including, for example, event data) for one or more incident objects in incident workflows 224 for eventual analysis or processing by one or more of the components described herein. Services 226 may include one or more software components that generate computer-readable instructions, one or more microservices, computing devices, computing systems, or other pieces of computing infrastructure. Services 226 may be operated, managed, monitored, and/or configured by one or more teams associated with operations computing system 210. Services 226 may be employed by applications of applications 221 to process tasks or workflows generated by any of applications 221. In some instances, services of services 226 may assign tasks to other services of services 226.

Incident engine 228 may orchestrate various actions related to analyzing event data. For example, incident engine 228 may determine incident data to include in each incident object. For example, incident engine 228 may determine tasks related to actions of alerting services 226 or teams of operations computing system 210 of an event. Incident engine 228 may determine tasks related to classifying events based on severity (e.g., critical, error, warning, information, unknown, etc.). Incident engine 228 may determine tasks related to determining a time frame or urgency for addressing an incident. Incident engine 228 may determine tasks related to outputting the severity of operations events to services 226 or teams of operations computing system 210. Incident engine 228 may determine tasks related to notifying relevant computing systems of incidents. Incident engine 228 may determine tasks related to prioritizing incidents for eventual processing. Incident engine 228 may determine tasks related to identifying templates of actions that may be used to resolve certain incidents in an automated way.

Workflow engine 232 may generate workflows for each incident object and orchestrate various actions related to the workflows for addressing incidents. For example, workflow engine 232 may generate an incident workflow for each of the one or more incident objects created by ingestion engine 222, in which each incident object includes incident data determined by incident engine 228, such as the event data, a priority level, an identifier, timestamps, incident type, incident source, severity level, urgency level, current incident status, one or more response actions, incident resolution, associated support tickets, and/or an action log. Workflow engine 232 may determine tasks related to jobs or processes of executing scripts, commands, or plugins that address incidents. Workflow engine 232 may determine tasks related to runbooks or a compilation of routine operating procedures for managing computing systems 150. Workflow engine 232 may map incidents to one or more workflows that may be executed to resolve at least part of an incident. Workflow engine 232 may employ services 226 to perform various actions, such as storing any incident workflows created for any incident objects in incident workflows 224 for eventual processing by one or more services of services 226.

In some examples, “generating” an incident workflow for each of the one or more incident objects may be or otherwise include generating an instance of an incident workflow. In some examples, a user of operations computing system 210 may be able to create one or more template incident workflows. In these examples, responsive to operations computing system 210 determining an incident, operations computing system 210 may assign, based on incident data and/or incident conditions associated with the incident, one or more template incident workflows to the incident. Additionally or alternatively, operations computing system 210 may trigger, instantiate, or execute an instance of the template incident workflow based on the incident. As such, operations computing system 210 may select, in response to determining the occurrence of an incident, and based on a set of previously configured conditions, one or more workflows to trigger or instantiate.

Resolution tracker 234 may monitor details related to the status of incidents determined by operations computing system 210. For example, resolution tracker 234 may monitor incident life-cycle metrics associated with incidents (e.g., creation time, acknowledgement time(s), resolution time, etc.), resources responsible for resolving the incidents (e.g., applications 221), and so on. Resolution tracker 234 may store data obtained from monitoring the details related to the status of incidents in database 223 for compilation by metrics 227.

In some examples, applications 221 may determine tasks associated with customers managed by operations computing system 210. In some instances, services of services 226 may determine tasks to be processed by other services of services 226. In some instances, engines 222, 228, and 232 may determine tasks to be processed by services of services 226. For example, ingestion engine 222 of applications 221 may determine tasks associated with ingesting operations events associated with customer computing systems. Incident engine 228 may determine tasks associated with determining incidents, classifying incidents, and/or notifying teams about incidents. Workflow engine 232 may determine incident workflows associated with templates of actions to resolve incidents. Applications 221 may store determined incident workflows in incident workflows 224.

Services 226 may be employed by an application of applications 221 to address incident workflows stored in incident workflows 224. For example, a service of services 226 may obtain instructions from ingestion engine 222 to perform actions related to incident workflows, such as resolving incidents. A service of services 226 may obtain instructions from incident engine 228 to perform actions related to determining incidents, classifying incidents, and/or notifying teams about incidents.

Database 223 may include incident workflows 224 and metrics 227. Metrics 227 may process the data related to the status of incidents into operations metrics. Metrics 227 may compute operations metrics such as mean-time-to-acknowledge (MTTA), mean-time-to-resolve (MTTR), incident count per resolvers, resolution escalations, uniqueness of events or incidents, auto-resolve rate, time-of-day of incidents, adjusting for multiplier events per single incident, service dependencies, infrastructure topology, or the like. In some instances, operations computing system 210 may replace certain incident data included in an incident object (e.g., a priority level) with new incident data based on metrics 227.

In accordance with the techniques described herein, operations computing system 210 may apply, using API module 252 of machine learning module 250, a machine learning model to determine an adjusted priority level for each of the one or more incident objects created by operations computing system 210 and associated with one or more incident workflows 224, such that a priority level for each incident workflow may more accurately be determined, and event data may be more effectively triaged by operations computing system 210. In some examples, a user may add data to a workflow, such as comments providing additional details (e.g., relating to the incident priority) that may also be passed into any models or algorithms implemented by operation computing system 210. As described above, in some examples, workflows 224 may include an “incident workflow action” that allows a user to assign the priority of an incident once an incident workflow is created. The incident workflow action may allow a user to configure multiple input parameters, e.g., a natural language prompt, for any models or algorithms used for interpreting and determining incident data, such as a priority level for the incident. In some examples, responsive to an incident workflow action being executed by operations computing system 210, machine learning module 250 may be executed. Specifically, machine learning module 250 may retrieve incident data from incident workflows 224 and execute API module 252 to initiate an API call to a machine learning model externally hosted on a platform. As such, one or more machine learning models described herein may be hosted on an external platform or included in an operating system of an external computing device (e.g., in a central intelligence layer of an operating system) and may be called or otherwise used by operations computing system 210, in which operations computing system 210 may communicate with the central intelligence layer (and model(s) stored therein) using an API (e.g., a common, public API). In some examples, a user of the operations computing system may initiate the API call.

In some examples, API module 252 may enable the exchanging of data in a standardized format, and may support, for example, REST (Representational State Transfer), which is an architectural style for building APIs that use HTTP (Hypertext Transfer Protocol) to exchange data between applications.

As described herein, the machine learning model implemented by machine learning module 250 may receive a first natural language prompt indicative of incident data included in the one or more incident objects associated with workflows 224. Additionally, the first natural language prompt may include explicit instructions for the machine learning model to determine an adjusted priority level for each of the one or more incident objects. For example, API module 252 may send a request including the natural language prompt to an API endpoint that executes one or more machine learning models based on the natural language prompt.

In some examples, the request including the natural language prompt may be received from a user. In some examples, the machine learning model may receive the request including the natural language prompt from a user via API module 252, a user interface, any other suitable method, or using any combination thereof. In some examples, the request may be received as input (e.g., via a user interface of system 100 of FIG. 1) to a client computer (such as computing systems 150 of FIG. 1) and transmitted via a network (such as network 130 of FIG. 1) to a network computer (such as a network computer of operations computing system 210).

In some examples, the machine learning model may receive a second natural language prompt indicative of additional instructions for determining the adjusted priority level for each of the one or more incident objects. In this way, users may further define the parameters for the machine learning model in accordance with their own definitions for incident priority levels. In some examples, however, the model may not receive a second natural language prompt from the user, and may determine the adjusted priority level based on only the first natural language prompt.

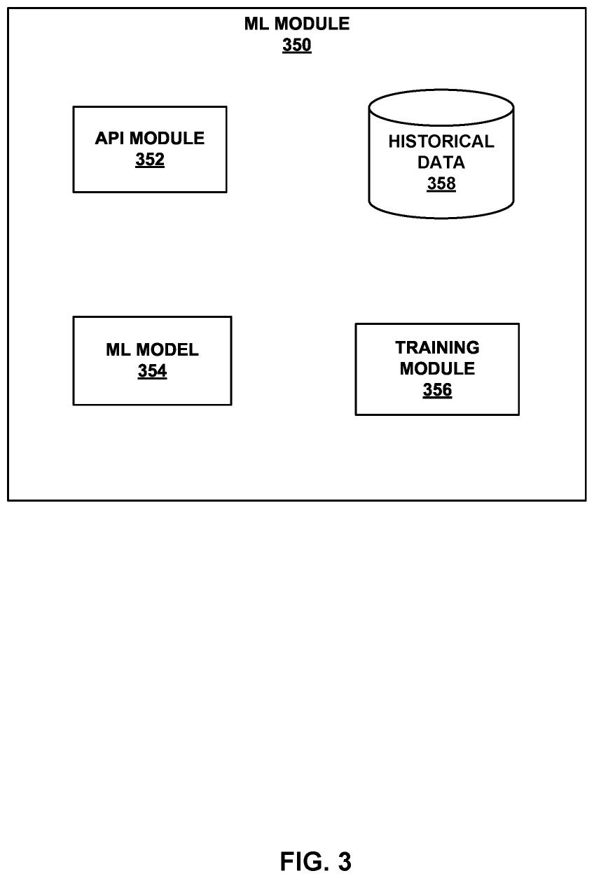

As described in more detail below with respect to FIG. 3, in some examples, the one or more natural language prompts may be automatically generated by machine learning module 250 using a machine learning model stored in operations computing system 210 and trained on historical data stored in operations computing system 210.

The response received by operations computing system 210 may include output data including the adjusted priority level determined by the machine learning model and the textual description that indicates reasoning for the adjusted priority level. Responsive to receiving the output data, operations computing system 210 may update the incident workflow and the associated incident object with the adjusted priority level. In some examples, operations computing system 210 may add the textual description to the incident workflow as reference for why the priority level had been adjusted. For example, an incident workflow may include a timeline of the incident, or a log of how the incident has changed over time. Operations computing system 210 may add the textual description to the incident workflow log to keep track of how the incident priority has changed over time.

The incident workflow may include one or more actions for addressing the incident. Operations computing system 210 may employ services 226 to perform the one or more actions based on the adjusted priority level for the incident workflow. As such, incidents may be addressed on a basis of priority rather than a basis of time at which the incident was determined. Thus, incidents with higher priority may be pushed to the front of a “queue,” or in other words, incident workflows for high priority incidents may be executed by operations computing system 210 before incident workflows for low priority incidents.

FIG. 3 is a conceptual diagram illustrating an example machine learning module for determining priority levels for incident objects, in accordance with techniques of this disclosure. FIG. 3 is discussed with respect to FIGS. 1-2 for example purposes only. In the example of FIG. 3, machine learning module 350 and API module 352 may be example implementations of machine learning module 250 and API module 252 of FIG. 2, respectively. As shown in the example of FIG. 3, machine learning module 350 also includes machine learning model 354, training module 356, and historical data 358. As described above, in some examples, the operations computing system described herein may use API module 352 to apply a machine learning model externally hosted on a platform to determine adjusted incident priority levels. In other examples, the operations computing system may apply a machine learning model locally stored in the operations computing system, such as machine learning model 354, to determine adjusted incident priority levels. As such, in some examples, the operations computing system described herein may be configured with one or more machine learning models for determining adjusted incident priority levels.

In some examples, machine learning module 350 may implement both machine learning model 354 and a machine learning model externally hosted on a platform that is called using API module 352. For example, the one or more natural language prompts provided to the external machine learning model may be automatically generated by machine learning module 350. Machine learning module 350 may apply machine learning model 354 to generate one or more natural language prompts based on historical data stored in historical data 358. Historical data 358 may include historical user data and/or historical incident workflow data. For example, historical data 358 may store data indicating common natural language prompts provided for determining adjusted priority levels for common incidents. As such, machine learning model 354 may optimize one or more natural language prompts for a request sent by API module 352.

The machine learning models described herein, such as machine learning model 354 and any other machine learning model utilized by the operations computing system (e.g., any models used via API module 352), may include one or more language models (e.g., a generative artificial intelligence model, a large language model, or the like). Machine learning module 350 may implement other machine-learned models that may be used in place of or in conjunction with one or more language models. Machine learning module 350 may perform various types of natural language processing (NLP) based on data received or stored by the operations computing system (e.g., incident data, user input data, etc.) or “input data”. Machine learning module 350 may use or send an API request to a platform that provides recurrent neural networks (RNNs) and/or transformer models (self-attention models), such as GPT-3, BERT, and T5. In some examples, machine learning module 350 may perform classification, summarization, name generation, regression, clustering, anomaly detection, recommendation generation, and/or other tasks.

In some examples, machine learning model 354 may be trained using training module 356. Machine learning model 354 may be trained online or offline. In some examples, machine learning model 354 may be trained on a static basis, in which training module 356 may train machine learning model 354 using historical data 358. In some examples, historical incident data may be manually labeled with priority levels. In these examples, training module 356 may fine-tune machine learning model 354 such that machine learning model 354 more accurately determines priority levels for incident objects.

In some examples, as described above, historical data 358 may store historical natural language prompts. In some examples, training module 356 may train one or more models implemented by machine learning module 350 to recognize invalid natural language prompts and valid natural language prompts. In some examples, at least some of the valid natural language prompt training data and/or the invalid natural language prompt training data may include respective descriptions of why the natural language prompt training data is either valid or invalid. To illustrate, the invalid natural language prompt training data may include an invalid natural language prompt such as, for example, “Write a haiku about a summer day.” Optionally, the invalid natural language prompt data may additionally include a description such as “this request is invalid because it is not related to incident priority level.” In another example, the valid natural language prompt training data may include a valid natural language prompt such as “Assess the priority level of the following incident based on urgency and severity. Provide a JSON response including a priority level assigned to one of P1-P5, in which P1 is the highest level of priority and P5 is the lowest level of priority, and an explanation including 1-2 sentences explaining why that priority level was chosen.” Optionally, the valid natural language prompt training data may additionally include a description such as “this request is valid because it relates to incident priority level.” In some examples, training module 356 may train one or more models implemented by machine learning module 350 to determine whether a natural language prompt is ambiguous or overly broad, such as “Determine the priority level based on the vulnerabilities found in the database.” Finding vulnerabilities may mean to look for security vulnerabilities, to look for relational issues or inconsistencies, or some other meaning. As such, machine learning module 350 may determine such requests to be invalid.

In some examples, as described above, machine learning model 354 may optimize one or more natural language prompts for a request sent by API module 352. In these examples, training module 356 may train machine learning model 354 to accurately identify relevant incident data to include in a natural language prompt, to generate a natural language prompt that is similar to natural language prompts stored in historical data 358, to accurately format the API request provided to API module 352, to accurately handle secrets, passwords, API tokens or keys, or any other data that require privacy or security, etc.

In some examples, machine learning module 350 may receive user input to further adjust the adjusted priority level for each of the one or more incident objects. In examples in which a user manually adjusts a priority level after machine learning module 350 has implemented one or more machine learning models to determine the adjusted priority level, data indicating this change may be stored in historical data 358 and used as training data by training module 356 to fine-tune the one or more machine learning models. In some examples, feedback may be provided to the one or more machine learning models immediately after the feedback data is received or in intervals.

As described above, the output of machine learning module 350 may include the adjusted priority level determined by one or more machine learning models implemented by machine learning module 350 and the textual description that indicates reasoning for the adjusted priority level. Responsive to receiving the output data, the operations computing system described herein may update each of the one or more incident objects associated with a respective workflow with the adjusted priority level and the textual description, and accordingly queue the incident workflow for processing. As such, the operations computing system described herein may process an incident workflow on the basis of priority. In some examples, based on the adjusted priority level, various actions of an incident workflow may be triggered (e.g., creating, generating, instantiating, etc.), such as creating a corresponding alert, sending a notification of the incident to a responder (i.e., a person, a group of persons, etc.), and/or triggering a response (e.g., a resolution or set of actions) to the incident. In this way, adjusted priority levels that result in an incident workflow being assigned a higher priority may additionally trigger actions that ensure an incident is handled accordingly.

By utilizing machine learning module 350, the techniques described herein may benefit from highly-trained artificial intelligence models that can help to reduce errors in incident analysis and management. Furthermore, the techniques described herein may allow users to fine-tune input as needed, and because input can be provided as natural language, may reduce the time and effort required to fine-tune such input. Additionally, by applying these models and fine-tuning processes, the operations computing system may assign more accurate priority levels to incident workflows, such that incidents are handled in a more efficient and appropriate manner. As such, the techniques described herein may improve the quality of service provided by the operations computing system.

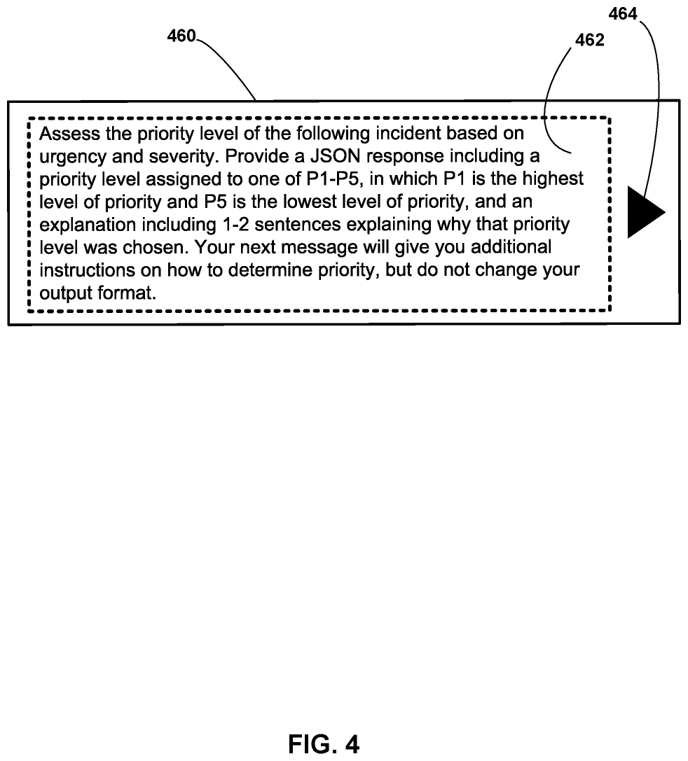

FIG. 4 is a conceptual diagram illustrating an example natural language prompt for adjusting priority levels of incident objects, in accordance with one or more aspects of the present disclosure. As described above, in some examples, the API request sent by API module 352 of FIG. 3 may include a natural language prompt that is received from a user. In some examples, the machine learning model may receive the request including the natural language prompt from a user via API module 352, a user interface, any other suitable method, or using any combination thereof. The example of FIG. 3 shows text entry field 460, which may be a text entry field included in a user interface generated by API module 352 or another module of any device or system described herein. As shown in the example of FIG. 4, in some examples, a user may enter natural language prompt 462 into text entry field 460 and click button 464 to enter natural language prompt 462. API module 352 may receive natural language prompt 462 and include natural language prompt 462 in the API request sent to the machine learning model. In other examples, text entry field 460 may be a feature of the machine learning model implemented by the operations computing system described herein, such that natural language prompt 462 is provided as direct input to the machine learning model (e.g., in examples in which an API request is not sent to an external platform).

In some examples, the natural language prompt (and in some examples, additionally or alternatively, the API request) may be received as input (e.g., via a user interface of system 100 of FIG. 1) to a client computer (such as computing systems 150 of FIG. 1 or other computing device) and transmitted via a network (such as network 130 of FIG. 1) to a network computer (such as a network computer of operations computing system 210). As such, the operations computing system described herein may receive the natural language prompt from one or more of a user computing device and a user interface generated by the operations computing system.

As described above, in some examples, one or more machine learning models described herein and/or API module 352 may determine whether the natural language prompt (and/or API request) from a user is valid. For example, a user may enter one or more natural language prompts into text entry field 460 that API module 352 may validate to ensure it is related to incident priority. As such, API module 352 may analyze the entered natural language prompt to determine whether the natural language prompt is related to an incident associated with one or more of workflows 224 and can be addressed by operations computing system 210. Responsive to determining that the first natural language prompt is valid, the operations computing system may then send an application programming interface request including the first natural language prompt via API module 352.

As shown in the example of FIG. 4, a valid natural language prompt 462 included in the request may contain the following string: “Assess the priority level of the following incident based on urgency and severity. Provide a JSON response including a priority level assigned to one of P1-P5, in which P1 is the highest level of priority and P5 is the lowest level of priority, and an explanation including 1-2 sentences explaining why that priority level was chosen. Your next message will give you additional instructions on how to determine priority, but do not change your output format.” As shown in this example, the machine learning model may be instructed to determine an adjusted priority level based on the severity level and the urgency level included in the incident data. In some examples, as indicated by the previous example, the machine learning model may receive a second natural language prompt via text entry field 460 indicative of additional instructions for determining the adjusted priority level for each of the one or more incident objects. As an example, following the previous example, the valid second natural language prompt entered into text entry field 460 and included in the request may contain the following string: “I am looking for high priority legal incidents, such as data breaches or privacy violations.” In this way, users may further define the parameters for the machine learning model in accordance with their own definitions for incident priority levels, or further fine-tune the machine learning model if the user determines the output of the machine learning model to be unsatisfactory.

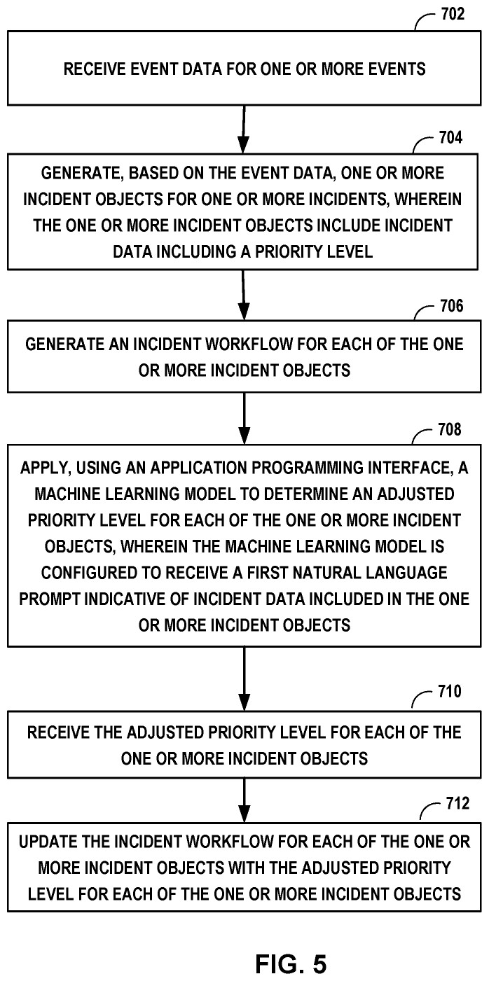

FIG. 5 is a flow chart illustrating an example process of adjusting priority levels of incident objects, in accordance with one or more aspects of the present disclosure. FIG. 5 is discussed with respect to FIGS. 1-4 for example purposes only.

Operations computing system 210 receives event data for one or more events (702). In some examples, operations computing system 210 receives event data corresponding to various events and/or performance metrics from computing systems 150 of customer sites 140. Applications 221 of operations computing system 210 generate, based on the event data, one or more incident objects for one or more incidents, in which the one or more incident objects include incident data including a priority level (704). Applications 221 of operations computing system 210 generate an incident workflow 124 for each of the one or more incident objects (706). Operations computing system 210 applies, using ML module 250 and/or API module 252, a machine learning model to determine an adjusted priority level for each of the one or more incident objects, in which the machine learning model is configured to receive a first natural language prompt indicative of incident data included in the one or more incident objects (708). In some examples, ML module 250 generates, based on historical data 358, the first natural language prompt. In some examples, ML module 250 and/or API module 252 determines whether the first natural language prompt is valid based on whether the first natural language prompt is related to incident priority level. In some examples, responsive to determining that the first natural language prompt is valid, operations computing system 210 sends, using API module 252, an application programming interface request including the first natural language prompt. In some examples, the machine learning model is configured to receive a second natural language prompt indicative of additional instructions for determining the adjusted priority level for each of the one or more incident objects. In some examples, each of the one or more incident objects is a structured representation of an incident. In some examples, the incident data further includes one or more of the event data, an identifier, timestamps, incident type, incident source, severity level, urgency level, current incident status, one or more response actions, incident resolution, associated support tickets, and an action log. In some examples, the adjusted priority level is determined based on severity level and the urgency level.

Operations computing system 210 receives the adjusted priority level for each of the one or more incident objects (710). In some examples, operations computing system 210 receives, from ML module 250, a description indicative of how the adjusted priority level for each of the one or more incident objects was determined. In some examples, operations computing system 210 receives user input via user interface device 216 to further adjust the adjusted priority level for each of the one or more incident objects. Operations computing system 210 updates each of the one or more incident objects associated with a respective workflow with the adjusted priority level for each of the one or more incident objects (712). In some examples, operations computing system 210 updates the incident workflow to include the description. In some examples, the incident workflow includes one or more actions for addressing an incident from the one or more incidents. In some examples, operations computing system 210 is configured to perform the one or more actions based on the adjusted priority level for the incident workflow.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
receiving, by a computing system, event data for one or more events;
generating, by the computing system, and based on the event data, one or more incident objects for one or more incidents, wherein the one or more incident objects include incident data including a priority level;
generating, by the computing system, an incident workflow for each of the one or more incident objects;
applying, by the computing system, and using an application programming interface, a machine learning model to determine an adjusted priority level for each of the one or more incident objects, wherein the machine learning model is configured to receive a first natural language prompt indicative of incident data included in the one or more incident objects;
receiving, by the computing system, the adjusted priority level for each of the one or more incident objects; and
updating, by the computing system, the incident workflow for each of the one or more incident objects with the adjusted priority level for each of the one or more incident objects.

2. The method of claim 1, wherein each of the one or more incident objects is a structured representation of an incident, and wherein the incident data further includes one or more of the event data, an identifier, timestamps, incident type, incident source, severity level, urgency level, current incident status, one or more response actions, incident resolution, associated support tickets, and an action log.

3. The method of claim 2, wherein the adjusted priority level is determined based on the severity level and the urgency level.

4. The method of claim 1, wherein the machine learning model is configured to receive a second natural language prompt indicative of additional instructions for determining the adjusted priority level for each of the one or more incident objects.

5. The method of claim 1, further comprising:
receiving, by the computing system and from the machine learning model, a description indicative of how the adjusted priority level for each of the one or more incident objects was determined; and
updating, by the computing system, the incident workflow to include the description.

6. The method of claim 1, wherein the computing system is further configured to receive user input to further adjust the adjusted priority level for each of the one or more incident objects.

7. The method of claim 1, wherein the incident workflow includes one or more actions for addressing an incident from the one or more incidents, and wherein the computing system is configured to perform the one or more actions based on the adjusted priority level for the incident workflow.

8. The method of claim 1, further comprising:
determining, by the computing system, whether the first natural language prompt is valid based on whether the first natural language prompt is related to incident priority level; and
responsive to determining that the first natural language prompt is valid, sending, by the computing system, and using the application programming interface, an application programming interface request including the first natural language prompt.

9. The method of claim 1, further comprising generating, by the computing system and based on historical data, the first natural language prompt.

10. A system comprising:
a memory; and
one or more processors having access to the memory, wherein the one or more processors are configured to:
receive event data for one or more events;
generate, based on the event data, one or more incident objects for one or more incidents, wherein the one or more incident objects include incident data including a priority level;
generate an incident workflow for each of the one or more incident objects;
apply, using an application programming interface, a machine learning model to determine an adjusted priority level for each of the one or more incident objects, wherein the machine learning model is configured to receive a first natural language prompt indicative of incident data included in the one or more incident objects; and wherein the adjusted priority level is determined based on a severity level and an urgency level;
receive the adjusted priority level for each of the one or more incident objects; and
update the incident workflow for each of the one or more incident objects with the adjusted priority level for each of the one or more incident objects, wherein the incident workflow includes one or more actions for addressing an incident from the one or more incidents, and wherein the system is configured to perform the one or more actions based on the adjusted priority level for the incident workflow.

11. The system of claim 10, wherein each of the one or more incident objects is a structured representation of an incident, and wherein the incident data further includes one or more of the event data, an identifier, timestamps, incident type, incident source, the severity level, the urgency level, current incident status, one or more response actions, incident resolution, associated support tickets, and an action log.

12. The system of claim 10, wherein the machine learning model is configured to receive a second natural language prompt indicative of additional instructions for determining the adjusted priority level for each of the one or more incident objects, and wherein the one or more processors are further configured to:
receive, from the machine learning model, a description indicative of how the adjusted priority level for each of the one or more incident objects was determined; and
update the incident workflow to include the description.

13. The system of claim 10, wherein the one or more processors are further configured to receive user input to further adjust the adjusted priority level for each of the one or more incident objects.

14. The system of claim 10, wherein the one or more processors are further configured to:
determine whether the first natural language prompt is valid based on whether the first natural language prompt is related to incident priority level; and
responsive to determining that the first natural language prompt is valid, send, using the application programming interface, an application programming interface request including the first natural language prompt.

15. The system of claim 10, wherein the one or more processors are further configured to generate, based on historical data, the first natural language prompt.

16. A computer-readable storage medium encoded with instructions that, when executed, cause at least one processor of a computing system to:
receive event data for one or more events;
generate, based on the event data, one or more incident objects for one or more incidents, wherein the one or more incident objects include incident data including a priority level;
generate an incident workflow for each of the one or more incident objects;
apply, using an application programming interface, a machine learning model to determine an adjusted priority level for each of the one or more incident objects, wherein the machine learning model is configured to receive a first natural language prompt indicative of incident data included in the one or more incident objects, and wherein the adjusted priority level is determined based on a severity level and an urgency level;
receive the adjusted priority level for each of the one or more incident objects; and
update the incident workflow for each of the one or more incident objects with the adjusted priority level for each of the one or more incident objects, wherein the computing system is further configured to receive user input to further adjust the adjusted priority level for each of the one or more incident objects, wherein the incident workflow includes one or more actions for addressing an incident from the one or more incidents, and wherein the computing system is configured to perform the one or more actions based on the adjusted priority level for the incident workflow.

17. The computer-readable storage medium of claim 16, wherein each of the one or more incident objects is a structured representation of an incident, and wherein the incident data further includes one or more of the event data, an identifier, timestamps, incident type, incident source, the severity level, the urgency level, current incident status, one or more response actions, incident resolution, associated support tickets, and an action log.

18. The computer-readable storage medium of claim 16, wherein the machine learning model is configured to receive a second natural language prompt indicative of additional instructions for determining the adjusted priority level for each of the one or more incident objects, and wherein the at least one processor is further configured to:
receive, from the machine learning model, a description indicative of how the adjusted priority level for each of the one or more incident objects was determined; and
update the incident workflow to include the description.

19. The computer-readable storage medium of claim 16, wherein the at least one processor is further configured to:
determine whether the first natural language prompt is valid based on whether the first natural language prompt is related to incident priority level; and
responsive to determining that the first natural language prompt is valid, send, using the application programming interface, an application programming interface request including the first natural language prompt.

20. The computer-readable storage medium of claim 16, wherein the at least one processor is further configured to generate, based on historical data, the first natural language prompt.
